(19) United States
(12) Patent Application Publication
(10) Pub. No.: US 2023/0313572 A1
(43) Pub. Date: Oct. 5, 2023

(54) RAILROAD CONTAINER LOCKING BAR AND METHOD OF USE

(71) Applicant: GREG HABER, Carlstadt, NJ (US)

(72) Inventor: GREG HABER, Carlstadt, NJ (US)

(21) Appl. No.: 18/194,807

(22) Filed: Apr. 3, 2023

Related U.S. Application Data
(60) Provisional application No. 63/380,086, filed on Oct. 19, 2022.
(60) Provisional application No. 63/373,351, filed on Aug. 24, 2022.
(60) Provisional application No. 63/327,398, filed on Apr. 5, 2022.

(51) Int. Cl. E05B 83/10

(52) U.S. Cl. CPC E05B 83/10

(57) ABSTRACT

The locking bar is magnetically attached to a container having a door which swings to a closed position to prevent access to the container. The locking bar includes a base and a blocking part extending from the base. The blocking part is located to prevent movement of the door from the closed position when the container is situated on the base. The weight of the container on the base prevents the locking bar from being removed from the container. Protrusions extending from the top of the base and from the bottom of the base further secure the locking bar from removal. A second blocking part may extend in a direction opposite the first locking bar for securing doors on stacked containers.

### CROSS-REFERENCE TO RELATED APPLICATIONS

Priority is claimed on Provisional Patent Application No. 63/327,398, filed Apr. 5, 2022, Provisional Patent Application No. 63/373,351, filed Aug. 24, 2022, and Provisional Patent Application No. 63/380,086, filed Oct. 19, 2022, the contents of each of which is incorporated herein by reference.

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

### 1. Field of the Invention

The present invention relates to railroad container security and more blocking particularly to a locking bar for securing the door of a railroad container to prevent unauthorized entry to the container.

### 2. Description of Prior Art Including Information Disclosed Under 37 CFR 1.97 and 1.98

Data shows that the crime of “pilferage” (stealing portions of a load instead of the entire trailer or container with a load) is increasing dramatically, especially in the “last mile” situation where the trailer or container with the load is parked at or near its destination before the trailer or container is unloaded. That is blocking particularly true with respect to loads in stacked railroad containers.

For example, there has been an over 160% increase in rail cargo theft in LA county since December 2020. On average, more than 90 containers compromised each day. In months during that period, increases over prior year surpassed 200%. For October 2021, there was an estimated increase of over 356% compared to the year before.

In the theft scenario, the thieves wait until the train with the container is stopped or is moving very slowly. Theft teams board the railcar bearing containers and look for those most easy to breach. Usually, the target is the upper container because the doors on the bottom containers are not accessible. Cutting wheels with various blades (diamond and non-diamond), bolt cutters, crow bars and various types are used to force to open doors.

Even high-grade padlocks are no match for battery powered saws with diamond blades. Once the locking system is breached the thief(s) tosses packages to on ground runners. These runners open the packages to identify the most valuable goods, load waiting vehicles and deblocking part with the stolen goods.

Pilferage theft is frequently not reported and there is no record of where or when the theft occurred. Drivers or train operators may not even know that a pallet is missing from a full container load until the container is unloaded and the contents is counted.

Integrated tracking, monitoring, hardened access systems, shipment tampering verification tools and cooperation with law enforcement can mitigate these issues to some extent, but a better pilferage prevention system is needed, blocking particularly for use on stacked containers on railroad cars.

In order to be practical, a locking device must be easy to install in a short amount of time, without special tools or skill. It must operate reliably to allow the locking bar to be removed to open the door. The parts should not wear out or be too expensive.\

The locking bar of the present invention is reusable. It takes less than a minute to install and remove during normal railroad operations of loading and unloading of containers. It minimizes certain safety hazards which arise when there is a break in and the container door is left open. Since the train cannot move until the doors are closed, a railroad employee must climb over eight feet to close the door, often resulting in injury.

The present invention is a locking bar for trailer and railroad containers which is magnetically attached to the container before the container is lowered into place on the trailer or railroad car. Once installed, the locking bar utilizes the weight of the container to prevent removal of the locking bar such that the container door cannot be opened. The locking bar has a layered structure which makes it virtually indestructible. It cannot be moved out of position by a crowbar or cut by bolt cutters or heavy-duty saws.

When the container is removed from the trailer or railroad car for unloading, the weight of the container is no longer pressing on the locking bar, and the locking bar is easily removed. The locking bar can be used repeatedly and is therefore economical to use as well as being highly effective.

### BRIEF SUMMARY OF THE INVENTION

The locking bar of the present invention is designed to secure a container as the container is transported on a trailer, railroad car or other vehicle having a door which swings to a closed position to prevent access to the container. The locking bar includes a base and a blocking part extending from the base. The blocking part is located to prevent movement of the door from the closed position when the container is situated over the base. The weight of the container on the base prevents the locking bar from being removed from under the container such that the container door cannot be opened and the contents of the container removed.

The locking bar blocking part extends from the base in a direction substantially perpendicular to the base. The locking bar base has an end. The locking bar blocking part extends from the base proximate the base end. The blocking part is welded to the base proximate to the base end.

The locking bar base and blocking part are fabricated in layers for extra strength. Preferably, the locking bar layers are formed of different metals, such as spaced layers of stainless steel with a layer of extra hard metal therebetween. In some cases, the layer be formed of a combination of metal and ceramic for additional strength.

The locking bar blocking part includes one magnet or a series of spaced magnets. The locking bar magnets face the container door when the container is situated on the base. The magnets attached the locking bar to the container as the container is lower onto the top of vehicle or lower container.

The surface of the locking bar base also has one or more magnets. Those magnets are situated in recesses in the base surface so as not to interfere then the locking bar slides into position on the container.

The locking bar base has a cushion associated with its bottom surface. The cushion is attached to the bottom surface of the base by a metal strip. The top of the metal strip is welded to the base. The cushion is joined to the bottom of the metal strip. The cushion is compressed as the container with the attached locking bar is lowered into the top of a container to ensure the entire weight to the container sits on top of the locking bar base.

In one embodiment, the locking bar base has a top surface. A first protrusion extends upwardly from the top base surface at a location spaced from the first blocking part. The first protrusion is located such that as the container is lowered onto on the locking bar base the first protrusion is received into a channel in the bottom of the container to further secure the locking bar to prevent removal.

In one embodiment, a second protrusion extends downwardly from the bottom base surface at a location spaced from the first blocking part. The second protrusion is located such that when the container with the attached locking bar is lowered onto the top of a container, the second protrusion is received in a channel in the container, further securing the locking bar against removal.

The locking bar may also have an “L” shaped corner cover protecting the welded joint between the base and the blocking part. Preferably, a corner cover is provided for each side of the locking bar.

In accordance with another aspect of the present invention, a locking bar is provided for first and second stacked containers. Each container has a door which swings to a closed position to prevent access to the container. The locking bar includes a base, a first blocking part extending upwardly from the base in one direction and a second blocking part extending downwardly from the base in another direction, opposite to the first blocking part.

The first blocking part is situated in the path of movement of the door of the first container to prevent the door of the first container from moving from the closed position, when the base is in position between the containers.

The second blocking part is situated in the path of movement of the door of the second container to prevent the door of the second container from moving from the closed position when the base is in position between the containers.

When the first container is situated on the base, the weight of the first container on the base prevents the locking bar from being removed from between the first and the second containers, and the doors of both containers from being opened.

At least one of the blocking parts of the locking bar and preferably both are formed of layers of different metals.

In accordance with another aspect of the present invention, a method of securing the door of a container on a vehicle in transit between a location where the container is loaded, and the destination of the vehicle is provided.

The container door is of the type which swings to a closed position to prevent access to the container by a locking bar. The locking bar includes a base and a blocking part.

The method comprises the steps of: loading the container, moving the container door to the closed position, magnetically attaching the locking bar to the container with the locking bar base under the container and the locking bar blocking part alongside the container door, lowering the container with the attached locking bar onto the vehicle such that the locking bar blocking part prevents the container door from moving away from the closed position when the container is placed over the base.

In that position, the weight of the container on the locking bar base prevents the locking bar from being removed from the container. The container with the attached locking bar is lifted from the vehicle when the vehicle reaches the destination, the locking bar is removed from the container, such that the door can be moved away from the closed position, and the container unloaded.

### BRIEF DESCRIPTION OF THE SEVERAL VIEWS OF DRAWINGS

To these and to such other objects that may hereinafter appear, the present invention relates to a locking bar for a railroad container locking bar and method of use as described in detail in the following specification and recited in the annexed claims, taken together with the accompanying drawings, in which:

FIG. 1 is a first perspective view of a first preferred embodiment of the locking bar showing the bottom and right side thereof.

FIG. 2 is a second first perspective view of a first preferred embodiment of the locking bar showing the bottom and left side thereof.

FIG. 3 is a third perspective view of a first preferred embodiment of the locking bar showing the top and left side thereof.

FIG. 4 is an elevation view of the left side of a first preferred embodiment the locking bar with the parts exploded.

FIG. 5 is an elevation view of the left side of the locking bar of a first preferred embodiment as it would appear attached to a container.

FIG. 6 is an elevation view of sections of stacked containers with the locking bar of a first preferred embodiment mounted on the containers.

FIG. 7 is an elevation view of the rear of stacked containers with the locking bar of a first preferred embodiment mounted on the containers.

FIG. 8 is a perspective view of stacked containers and the first preferred embodiment of the locking bar shown exploded prior to attachment of the locking bar.

FIG. 9 is a first perspective view of a second preferred embodiment of the locking bar showing the bottom and right side thereof.

FIG. 10 is a second first perspective view of a second preferred embodiment of the locking bar showing the bottom and left side thereof.

FIG. 11 is a third perspective view of a second preferred embodiment of the locking bar showing the top and left side thereof.

FIG. 12 is a perspective view of stacked containers and the second preferred embodiment of the locking bar shown exploded prior to attachment of the locking bar.

FIG. 13 is a first perspective view of a third preferred embodiment of the locking bar showing the bottom and right side thereof.

FIG. 14 is a second perspective view of a third preferred embodiment of the locking bar showing the bottom and left side thereof.

FIG. 15 is a third perspective view of a third preferred embodiment of the locking bar showing the top and left side thereof.

FIG. 16 is a perspective view of stacked containers and the third preferred embodiment of the locking bar shown exploded prior to attachment of the locking bar.

### DETAILED DESCRIPTION OF THE INVENTION

The locking bar of the present invention is designed to secure a container having a door which swings to a closed position to prevent access to the container, as the container is transported. It can be used to protect the load in any size or type of container being moved by any kind of vehicle, including a trailer or ship. However, the locking bar of the present invention is specifically designed to prevent pilfering from a container on a railroad car and is therefore described for purposes of illustration in the following text shown in the drawings as it would be used in that environment.

Railroad cars typically carry containers arranged on a frame in side by side stacks, each stack including two containers situated one on top of another with a small gap in between. Each container has left and right side by side swinging doors which can be opened to access the container interior.

When the doors of a container are closed, the doors interlock such that one door, for example the left door, cannot be opened unless the other door, for example the right door, is open. Moreover, the top container in the stack will prevent the door of the bottom container from being opened when the top container is in place. Thus, a single locking bar installed on the right door of the top container will prevent access to the container doors of the top container and the doors of the bottom container.

Although the following figures show the locking bar installed on the right door of the container, for extra protection, a second looking bar may be used to secure the left door.

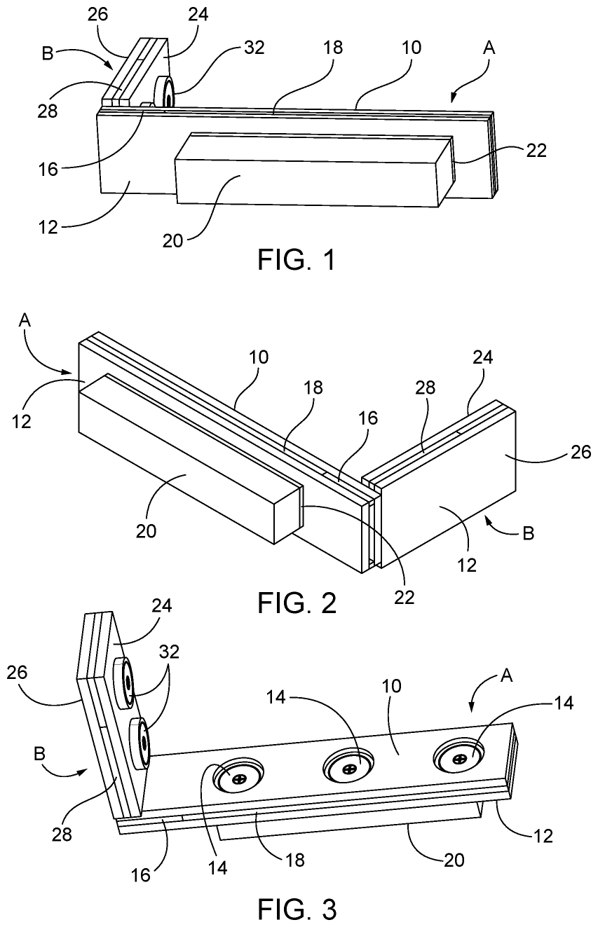

FIGS. 1, 2 and 3 show perspective views of a first preferred embodiment of the locking bar. As seen in those figures, the locking bar includes a base, generally designated A, and a blocking part, generally designated B, extending from the top surface 10 of base A. When base A is situated in the gap between the stacked containers and the container is situated on surface 10 of base A, blocking part B is located adjacent the container door and prevents movement of the container door from the closed position. The weight of the container on base A prevents the locking bar from being removed from under the container such that the container door cannot be opened, and the contents of the container cannot be pilfered.

Locking bar blocking part B extends from the base surface 10 in a direction substantially perpendicular to the base surface. Locking bar blocking part B is securely welded to one end of the base surface 10, forming a corner.

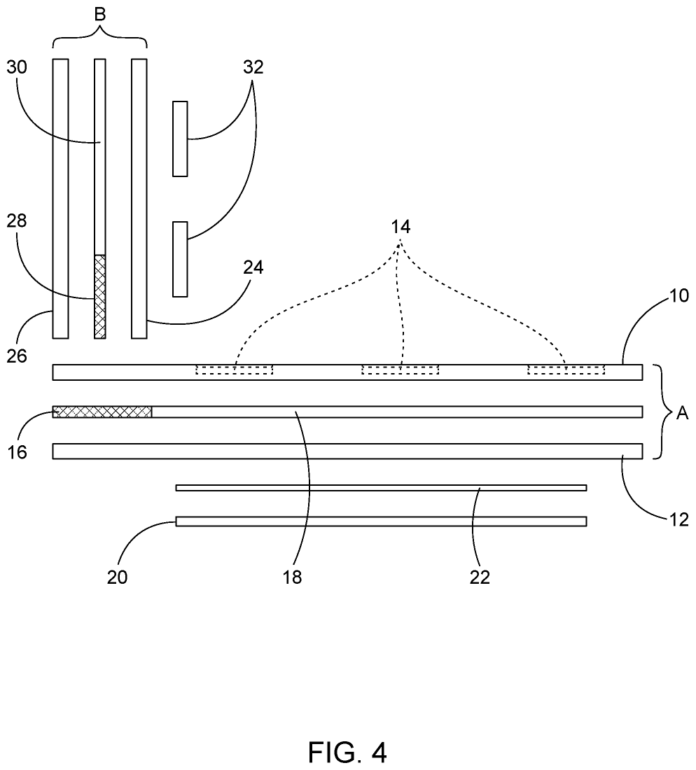

FIG. 4 shows the components of the locking bar exploded. That figure shows that locking bar base A and blocking part B are each fabricated of multiple layers for extra strength.

Base A is formed of a top layer 10, a bottom layer 12 both fabricated of stainless steel. Between layers 10 and 12 is an intermediate layer including an insert 16 of extra high strength metal. One end of insert 16 is situated proximate the corner of the base where the blocking part is attached to the base. Layers 10, 12 and 16 are welded together to form a very strong multi-layer part which cannot be bent by a crowbar.

Insert 16 may extend from the corner along the entire length of base A. Alternatively, insert 16 may extend part way along the base to save the cost of the extra high strength metal. In the latter case, a layer of stainless steel 18 is provided in the opening between the top and bottom layers an welded between layers 10 and 12.

Forming locking bar base A in layers of different metals greatly increases the strength of the base. The spaced layers 10 and 12 of stainless steel combined with a layer 16 of extra strength metal therebetween make the base highly resistant to cutting by saws with diamond blades or any other forced entrance to the container.

Blocking part B is also formed of layers of different metals welded together. It includes an inner layer 24 and an outer layer 26 of stainless steel. Between layers 24 and 26 is a layer 28 of extra high strength metal extending from the corner. Layer 28 may extend the entire length of blocking part B or part way the along blocking part B. to reduce cost. In the latter case, a layer of stainless steel 30 is provided in the opening between the inner and outer layers and welded in place between layers 24 and 26.

Forming blocking part B in layers of different metals greatly increases the strength of the blocking part. The spaced stainless steel layers 24 and 26 combined with a layer 28 of extra strength metal welded therebetween make the blocking part highly resistant to forced entrance to the container.

The top layer 10 of base A includes at least one magnet 14. Preferably, a series of spaced magnets 14 are provided. Magnets 14 function to maintain the base in contact with the bottom of the container as the top container is lowered onto the top of the bottom container in the stack. The magnets are recessed into the base such that the base can easily slide under the top container.

Blocking part B also includes at least one magnet 32. Preferably two spaced magnets 32 are provided. Magnets 32 need not be recessed and will face the container door when the locking bar is situated on the base. The magnets maintain the locking bar attached to the container as the top container is lower onto the top of the bottom container.

Locking bar base A has a cushion assembly associated with its bottom layer surface 12. The cushion assembly includes a rubber or other compressible material portion 20 fixed to one side of a metal strip 22. The other side of metal strip 22 is welded to the surface of bottom layer 12. Portion 20 of the cushion is compressed as the container with the attached locking bar is lowered into the top of the bottom container to compensate for any difference in spacing between the locking bar base and the top of the container and to ensure the entire weight to the container is distributed evenly on the locking bar base.

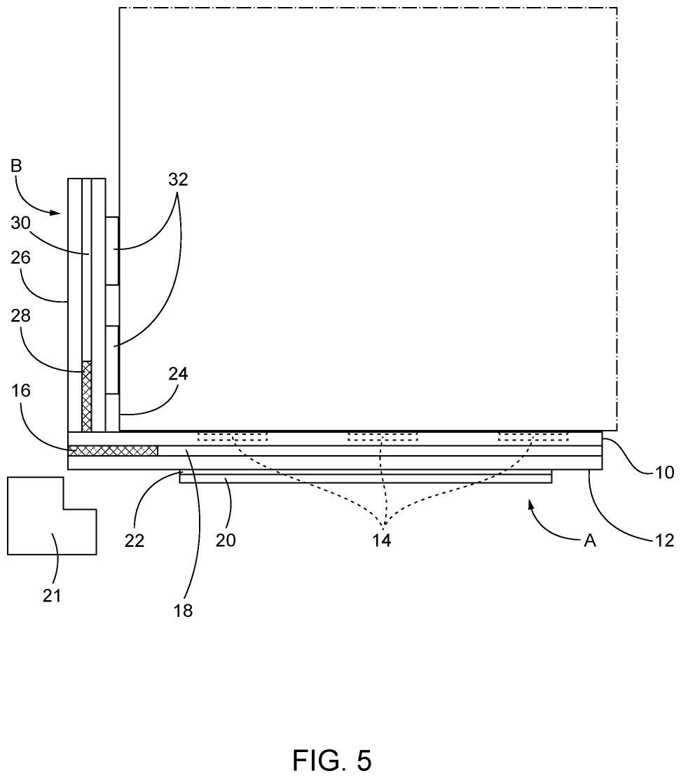

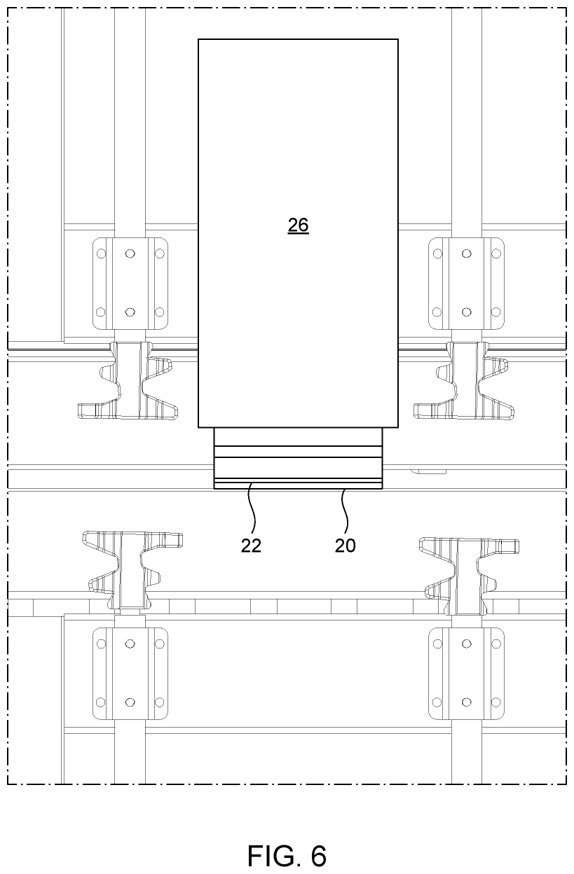

FIG. 5 shows the locking bar installed on a container with the weight of the container on base A and blocking part B in adjacent the front of the container door which is in the closed position. Also shown in this figure is an “L” shaped corner cover 21 which further protects the weld between base A and the blocking part B. A second “L” shaped corner cover 21 (not shown) can be employed to protect the weld on the other side of the locking bar.

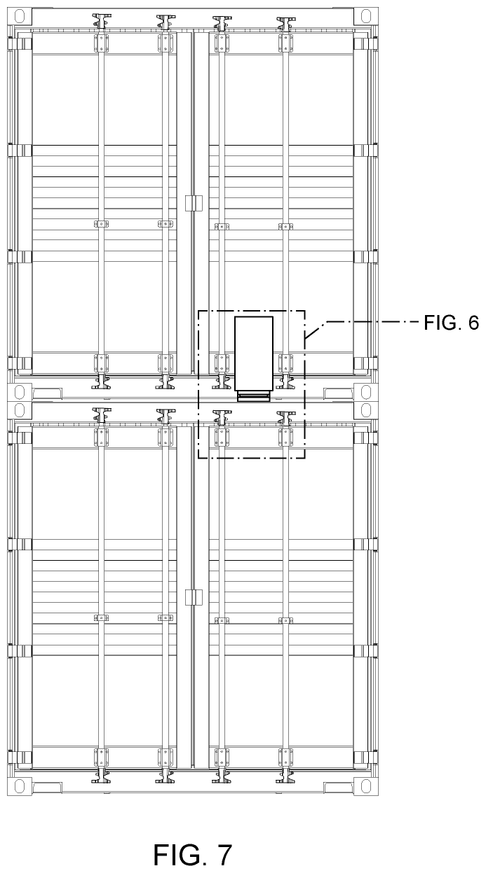

FIG. 6 shows the locking bar in position on stacked containers with base A inserted into the gap between a portion of the bottom of the top container and a portion of the top of the bottom container.

FIG. 7 shows side-by-side stacked containers with the locking bar in position between the bottom of the top container and the top of the bottom container in a stack.

FIG. 8 shows an exploded perspective view of two containers and the locking bar, prior to attachment of the locking bar to the top container, and prior to the top container with the attached locking bar is lowered onto the bottom container in a stack.

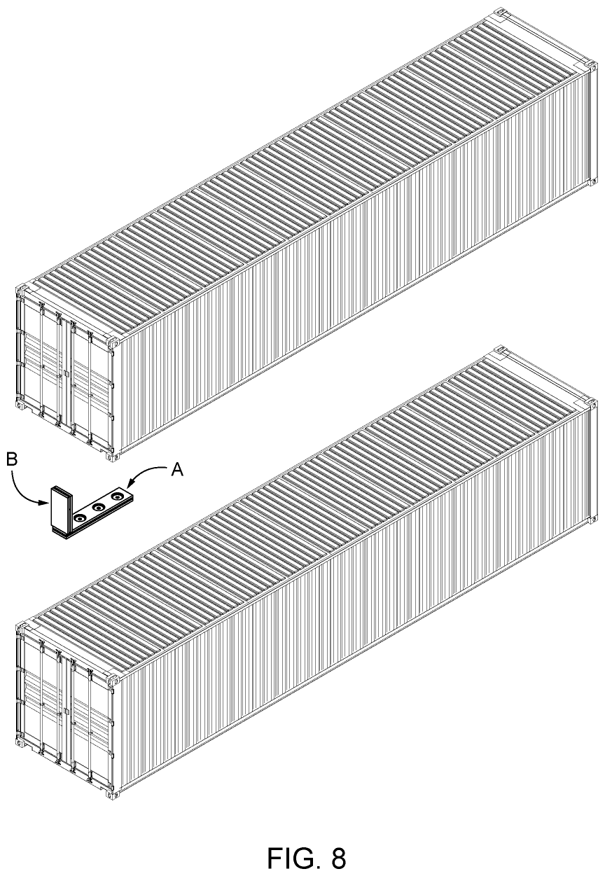

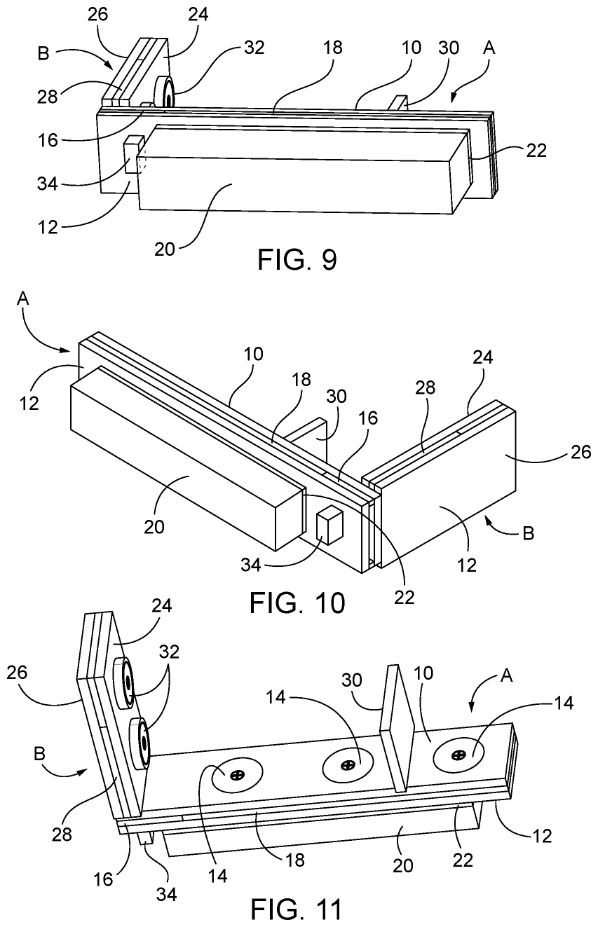

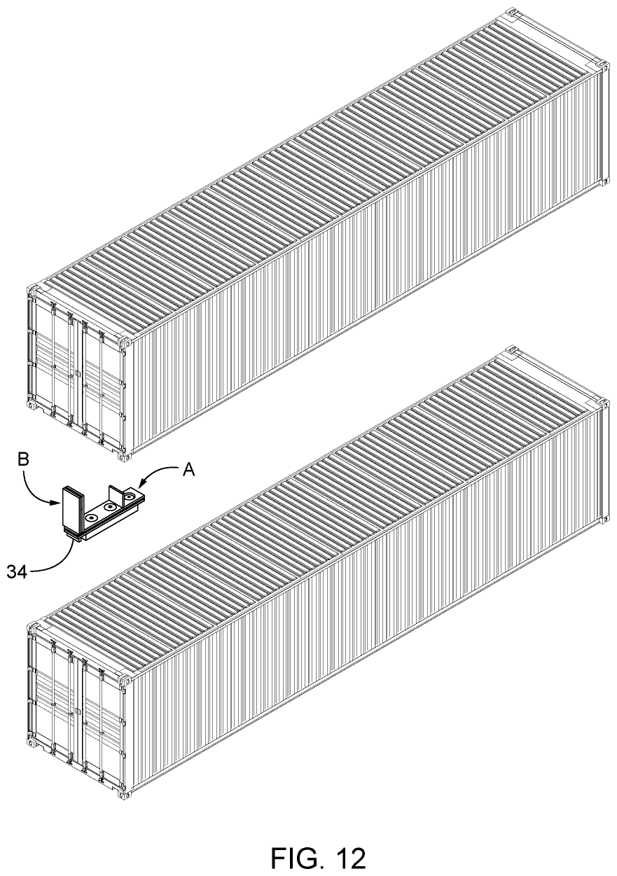

FIGS. 9, 10 and 11 show perspective views of a second preferred embodiment of the locking bar which includes top and bottom protrusions that further prevent the locking bar from being extracted from between the containers. FIG. 12 illustrates the second preferred embedment of the locking bar before it is attached to the top container and before the top container with the attached locking bar is lowered onto the bottom container in the stack.

In this embodiment, an additional protrusion 30 is provided which extends upwardly from the top base surface 10 in a direction parallel with blocking part B, at a location spaced from the blocking part B. Protrusion 30 is located such that as the when the locking bar is attached to the lower surface of the top container in a stack, the protrusion is received in a channel in the bottom surface of the top container, as seen in FIG. 12.

Also included in this embodiment is a protrusion 34. Protrusion 34 extends downwardly from the bottom base surface 12 at a location spaced a short distance between the end of the base and cushion 20. Protrusion 34 is located such that when the top container of the stack with the attached locking bar is lowered onto the top of the bottom container, protrusion 34 is received in a channel in the top of the bottom container, as seen in FIG. 12.

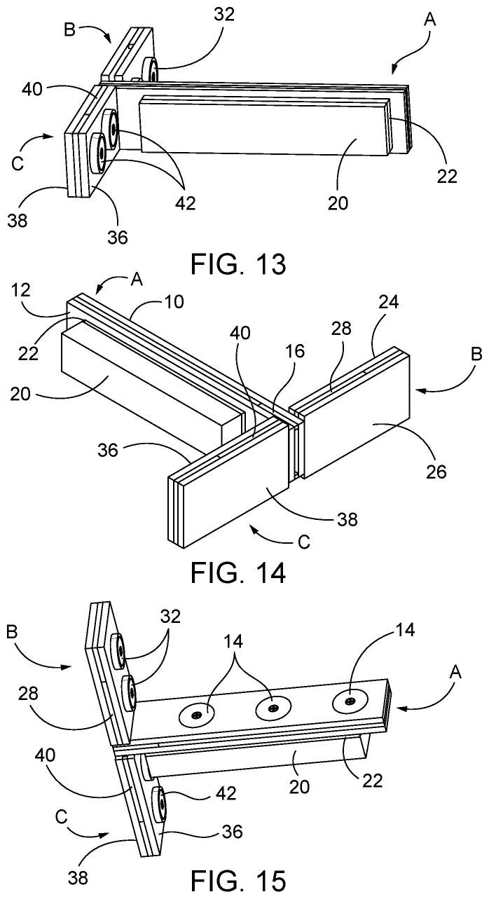

FIGS. 13, 14 and 15 show different perspective views of a third preferred embodiment of the locking bar. This embodiment of the locking bar is designed to provide extra security against the opening of the door of the lower container in a stack when the locking bar is installed. This embodiment includes a second blocking part, generally designated C. Blocking bar C extends downwardly from base A in a direction opposite to blocking part B. When the locking bar is installed, blocking bar C is situated adjacent to the door of the lower container and provides extra security against opening of the door of the bottom container.

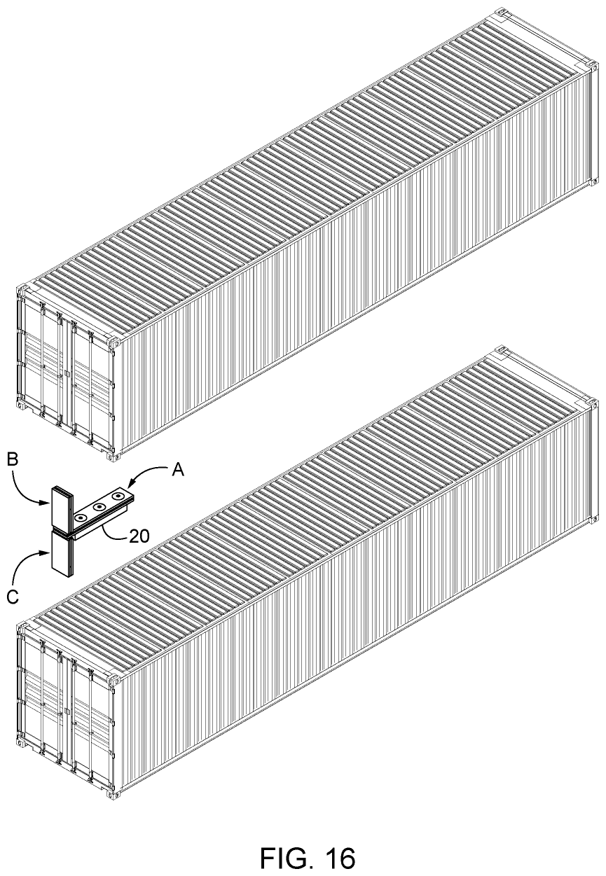

FIG. 16 shows top and bottom containers before the third embodiment of the locking bar is attached to the top container and before the top container with the locking bar attached is lowered on to the bottom container of the stack.

When the top container with the locking bar attached is lowered into position over the top of the bottom container in the stack, blocking part C is situated adjacent the door of the lower container. In that position, blocking part C provides additional security preventing movement of the door of the lower container from the closed position.

As in the other embodiments, when the top container is situated on the base, the weight of the top container prevents the locking bar from being removed from the gap between the top and bottom containers in the stack.

Blocking bar C is formed of layers of different metals 36, 38 and 40 for increased strength. It may also include magnets 42 which would allow the blocking part C to be attached to the bottom container before the top container of the stack is lowered onto the bottom container.

The locking bar of the present invention is designed to be used to secure the door of a container on a railroad car to prevent pilferage in transit between the location where the container is loaded and the destination where the container is to be unloaded. The container door is of the type which swings to a closed position to prevent access to the container. The locking bar includes a base which is inserted in the gap between stacked containers and has a blocking part adjacent to the door which maintains the door in the closed position.

When the container is loaded and the container door is moved to the closed position, the container is loaded onto the railroad car. Prior to lowering the container on the railroad car, the locking bar is magnetically attached to the container. In that position, locking bar base A is situated under the container and locking bar blocking part B is adjacent the container door. The container with the attached locking bar is then lowered onto the railroad car.

Once the container with the attached locking bar is lowered onto the railroad car, the weight of the container on the locking bar base prevents the locking bar from being removed. As long as the container remains in place on the railroad car, the locking bar prevents the container door from being moved from the closed position, protecting the load in the container against pilfering.

The railroad car with the container is then moved toward the destination where the container with the attached locking bar is lifted from the railroad car. As the container is lifted, the locking bar is removed from the container, such that the door can be moved away from the closed position, and the container, with the load intact, can be unloaded.

The locking bar can be used repeatedly. It is an economical, efficient, and very effective means of securing any size or type of container in transit against pilferage without having to modify the container. It does not require any special tools or skills to install or remove.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

I claim:

1. A locking bar for a container having a door which swings to a closed position to prevent access to the container, said locking bar comprising a base and a blocking part extending from said base, said blocking part being located to prevent movement of the door from the closed position when the container is situated over the base, wherein the weight of the container on said base prevents said locking bar from being removed from under the container.

2. The locking bar of claim 1 wherein said blocking part extends from said base in a direction substantially perpendicular to said base.

3. The locking bar of claim 1 wherein said base has an end and wherein said blocking part extends from said base proximate said end.

4. The locking bar of claim 3 wherein said blocking part is welded to said base proximate to said base end.

5. The locking bar of claim 1 wherein said blocking part is comprised of layers.

6. The locking bar of claim 1 wherein said blocking part is comprised of layers of different metals.

7. The locking bar of claim 1 wherein said blocking part is comprised of spaced layers of stainless steel with a layer of an extra strength metal therebetween.

8. The locking bar of claim 1 wherein said base is comprised of layers.

9. The locking bar of claim 1 wherein said base is comprised of layers of different metals.

10. The locking bar of claim 1 wherein said base is comprised of spaced layers of stainless steel with a layer of an extra strength metal therebetween.

11. The locking bar of claim 1 wherein said blocking part comprises a magnet.

12. The locking bar of claim 1 wherein said blocking part comprises spaced magnets.

13. The locking bar of claim 1 wherein said blocking part comprises a surface which faces the container door when the container is situated on said base and further comprises a magnet situated on said blocking part surface.

14. The locking bar of claim 1 wherein said base comprises a magnet.

15. The locking bar of claim 1 wherein said base comprises spaced magnets.

16. The locking bar of claim 1 wherein said base comprises a surface which faces the bottom of the container when the container is situated on said base and further comprises a magnet associated with said base surface.

17. The locking bar of claim 14 wherein said base surface comprises a recess and said magnet is situated within said recess.

18. The locking bar of claim 1 wherein said base has a bottom surface and further comprising a cushion associated with said bottom base surface.

19. The locking bar of claim 1 further comprising a cushion attached to said base by a metal layer welded to said base.

20. The locking bar of claim 1 wherein said base has a top surface and further comprising a protrusion extending from said top base surface at a location spaced from said blocking part.

21. The locking bar of claim 1 wherein said base has a bottom surface and further comprising a protrusion extending from said bottom base surface at a location spaced from said first blocking part.

22. The locking bar of claim 1 wherein said container is loaded on a railroad car.

23. A locking bar for first and second stacked containers, each container having a door which swings to a closed position to prevent access to the container, said locking bar comprising a base, a first blocking part extending from said base in a first direction and a second blocking part extending from said base in a second direction, said first blocking part being located in the path of movement of the door of the first container to prevent movement the door of the first container from said closed position when said base is in position between the containers, said second blocking part being located in the path of movement of the door of the second container to prevent movement the door of the second container from said closed position when said base is in position between the containers, wherein the weight of the first container on said base prevents said locking bar from being removed from between the first and the second containers.

24. The locking bar of claim 23 wherein at least one of said blocking parts is comprised of layers of different metals.

25. The locking bar of claim 23 wherein said base has a top and a bottom and wherein said first blocking part extends from said base top and said second blocking part extends from said base bottom.

26. A method of securing the door of a container in transit from a location where the container is loaded, the container door being of the type which swings to a closed position to prevent access to the container, by a locking bar including a base and a blocking part, the method comprising the steps of:
(a) loading the container,
(b) moving the container door to the closed position,
(c) magnetically attaching the locking bar to the container with the locking bar base under the container and locking bar blocking part adjacent the container door,
(d) lowering the container with the attached locking bar onto a vehicle such that the locking bar blocking part prevents the container door from moving away from the closed position when the container is placed over the base,
(e) wherein the weight of the container on the locking bar base prevents the locking bar from being removed from the container,
(f) lifting the container with the attached locking bar from the vehicle when the vehicle reaches the location where the container is to be unloaded,
(g) detaching the locking bar from the container,
(h) moving the container door from the closed position, and
(i) unloading the container.

27. The method of claim 26 wherein the vehicle is a railroad car.
